(19) United States
(12) Patent Application Publication
(10) Pub. No.: US 2010/0049500 A1
(43) Pub. Date: Feb. 25, 2010

(54) DIALOGUE GENERATION APPARATUS AND DIALOGUE GENERATION METHOD

(75) Inventors: Yuka KOBAYASHI, Seto-shi (JP); Miwako Doi, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/544,430

(22) Filed: Aug. 20, 2009

(30) Foreign Application Priority Data
Aug. 20, 2008 (JP) 2008--211906

(51) Int. Cl. G06F 17/27

(52) U.S. Cl. 704/9; 704/235

(57) ABSTRACT

A dialogue generation apparatus includes a transmission/reception unit configured to receive incoming text and transmit return text, a presentation unit configured to present the contents of the incoming text to a user, a morphological analysis unit configured to perform a morphological analysis of the incoming text to obtain first words included in the incoming text and linguistic information on the first words, a selection unit configured to select second words that characterize the contents of the incoming text from the first words based on the linguistic information, a speech recognition unit configured to perform speech recognition of the user's speech after the presentation of the incoming text in such a manner that the second words are recognized preferentially, and produce a speech recognition result representing the contents of the user's speech, and a generation unit configured to generate the return text based on the speech recognition result.

### CROSS-REFERENCE TO RELATED APPLICATIONS

This application is based upon and claims the benefit of priority from prior Japanese Patent Application No. 2008-211906, filed Aug. 20, 2008, the entire contents of which are incorporated herein by reference.

### BACKGROUND OF THE INVENTION

1. Field of the Invention

This invention relates to a dialogue generation apparatus using a speech recognition process.

2. Description of the Related Art

In recent years, interactive means, including electronic mail, chat, and a bulletin board system (BBS), have been used by a lot of users. Unlike speech-based interactive means, such as the telephone or voice chat, the electronic mail, chat, BBS, and the like are text-based interactive means realized by the exchange of relatively short text items between users. When the user uses text-based interactive means, he or she uses a text input interface as input means, such as a keyboard or the numeric keypad of a mobile telephone. To realize a rhythmical dialogue by improving the usability in text input, a text input interface based on a speech recognition process may be used.

In the speech recognition process, the user's speech is converted sequentially into specific standby words on the basis of an acoustic viewpoint and a linguistic viewpoint, thereby generating language text composed of a string of standby words representing the contents of the speech. If the standby words are decreased, the recognition accuracy of individual words increases, but the number of recognizable words decreases. If the standby words are increased, the number of recognizable words increases, but the chances are greater that individual words will be recognized erroneously. Accordingly, to increase the recognition accuracy of the speech recognition process, a method of causing specific words expected to be included in the user's speech to be recognized preferentially or only the specific words to be recognized has been proposed.

With the electronic mail communication apparatus disclosed in JP-A 2002-351791, since a format for writing standby words in an electronic mail text has been determined previously, standby words can be extracted from the received mail according to the format. Therefore, with the electronic mail communication apparatus disclosed in JP-A 2002-351791, high recognition accuracy can be expected by preferentially recognizing the standby words extracted on the basis of the format. In the electronic mail communication apparatus disclosed in JP-A 2002-351791, however, if the specific format is not followed, standby words cannot be written in the electronic mail text. That is, in the electronic mail communication apparatus disclosed in JP-A 2002-351791, since the format of dialogue is limited, the flexibility of dialogue is impaired.

With the response data output apparatus disclosed in JP-A 2006-172110, an interrogative sentence is estimated from text data on the basis of a sentence end used at the end of an interrogative sentence. If there are specific paragraphs, including “what time” and “where,” in the estimated interrogative sentence, words representing time and place are recognized preferentially according to the respective paragraphs. If none of specific paragraphs, including “what time” and “where,” are present in the interrogative sentence, words, including “yes” and “no,” are recognized preferentially. Accordingly, with the response data output apparatus disclosed in JP-A 2006-172110, high recognition accuracy can be expected in the user's speech response to an interrogative sentence. On the other hand, the response data output apparatus does not improve the recognition accuracy in a response to a declarative sentence, an exclamatory sentence, and an imperative sentence other than an interrogative sentence.

With the speech-recognition and speech-synthesis apparatus disclosed in JP-A 2003-99089, input text is subjected to morphological analysis and only the words constituting the input text are used as standby words, which enables high recognition accuracy to be expected for the standby words. However, the speech-recognition and speech-synthesis apparatus disclosed in JP-A 2003-99089 has been configured to achieve menu selection, the acquisition of link destination information, and the like, and recognize only the words constituting the input text. That is, a single word or a string of a relatively small number of words has been assumed to be the user's speech. However, when text (return text) is input, words not included in the input text (e.g., incoming mail) have to be recognized.

### BRIEF SUMMARY OF THE INVENTION

According to an aspect of the invention, there is provided a dialogue generation apparatus comprising: a transmission/reception unit configured to receive first text and transmit second text serving as a reply to the first text; a presentation unit configured to present the contents of the first text to a user; a morphological analysis unit configured to perform a morphological analysis of the first text to obtain first words included in the first text and linguistic information on the first words; a selection unit configured to select second words that characterize the contents of the first text from the first words based on the linguistic information; a speech recognition unit configured to perform speech recognition of the user's speech after the presentation of the first text in such a manner that the second words are recognized preferentially, and produce a speech recognition result representing the contents of the user's speech; and a generation unit configured to generate the second text based on the speech recognition result.

### BRIEF DESCRIPTION OF THE SEVERAL VIEWS OF THE DRAWING

FIG. 1 is a block diagram showing a dialogue generation apparatus according to a first embodiment;

FIG. 2 is a flowchart for the process performed by the dialogue generation apparatus of FIG. 1;

FIG. 3 is a flowchart for a return-text generation process of FIG. 2;

FIG. 4A shows an example of incoming text received by the dialogue generation apparatus of FIG. 1;

FIG. 4B shows an example of the result of morphological analysis of the incoming text in FIG. 4A;

FIG. 5 shows an example of using the dialogue generation apparatus of FIG. 1;

FIG. 6A shows an example of incoming text received by the dialogue generation apparatus of FIG. 1;

FIG. 6B shows an example of the result of morphological analysis of the incoming text in FIG. 6A;

FIG. 7 shows an example of using the dialogue generation apparatus of FIG. 1;

FIG. 8 is a block diagram showing a dialogue generation apparatus according to a second embodiment;

FIG. 9 shows an example of using the dialogue generation apparatus of FIG. 8;

FIG. 10 shows an example of using the dialogue generation apparatus of FIG. 8;

FIG. 11 is a block diagram showing a dialogue generation apparatus according to a third embodiment;

FIG. 12 is a flowchart for a return-text generation process performed by the dialogue generation apparatus of FIG. 11;

FIG. 13 shows an example of writing related words in the related-word database of FIG. 11;

FIG. 14 is an example of using the dialogue generation apparatus of FIG. 11;

FIG. 15 shows an example of writing related words in the related-word database of FIG. 11;

FIG. 16 is an example of using the dialogue generation apparatus of FIG. 11;

FIG. 17 is a flowchart for the process performed by a dialogue generation apparatus according to a fourth embodiment;

FIG. 18 shows an example of segmenting incoming text received by the dialogue generation apparatus of the fourth embodiment;

FIG. 19 is an example of using the dialogue generation apparatus of the fourth embodiment;

FIG. 20 shows an example of segmenting return text generated by the dialogue generation apparatus of the fourth embodiment;

FIG. 21 shows an example of incoming text received by the dialogue generation apparatus of the fourth embodiment;

FIG. 22 is an example of using the dialogue generation apparatus of the fourth embodiment;

FIG. 23 shows an example of return text generated by the dialogue generation apparatus of the fourth embodiment;

FIG. 24 is a block diagram of a dialogue generation apparatus according to a fifth embodiment;

FIG. 25 is a flowchart for a return-text generation process performed by the dialogue generation apparatus of FIG. 24;

FIG. 26 shows an example of the memory content of a frequently-appearing-word storage unit in FIG. 24;

FIG. 27 shows an example of using the dialogue generation apparatus of FIG. 24;

FIG. 28 shows an example of the memory content of the frequently-appearing-word storage unit in FIG. 24;

FIG. 29 shows an example of using the dialogue generation apparatus of FIG. 24;

FIG. 30 shows an example of using a dialogue generation apparatus according to a sixth embodiment;

FIG. 31 shows an example of using the dialogue generation apparatus of the sixth embodiment;

FIG. 32 shows an example of using the dialogue generation apparatus of the sixth embodiment; and

FIG. 33 shows an example of using the dialogue generation apparatus of the sixth embodiment.

### DETAILED DESCRIPTION OF THE INVENTION

Hereinafter, referring to the accompanying drawings, embodiments of the invention will be explained.

### First Embodiment

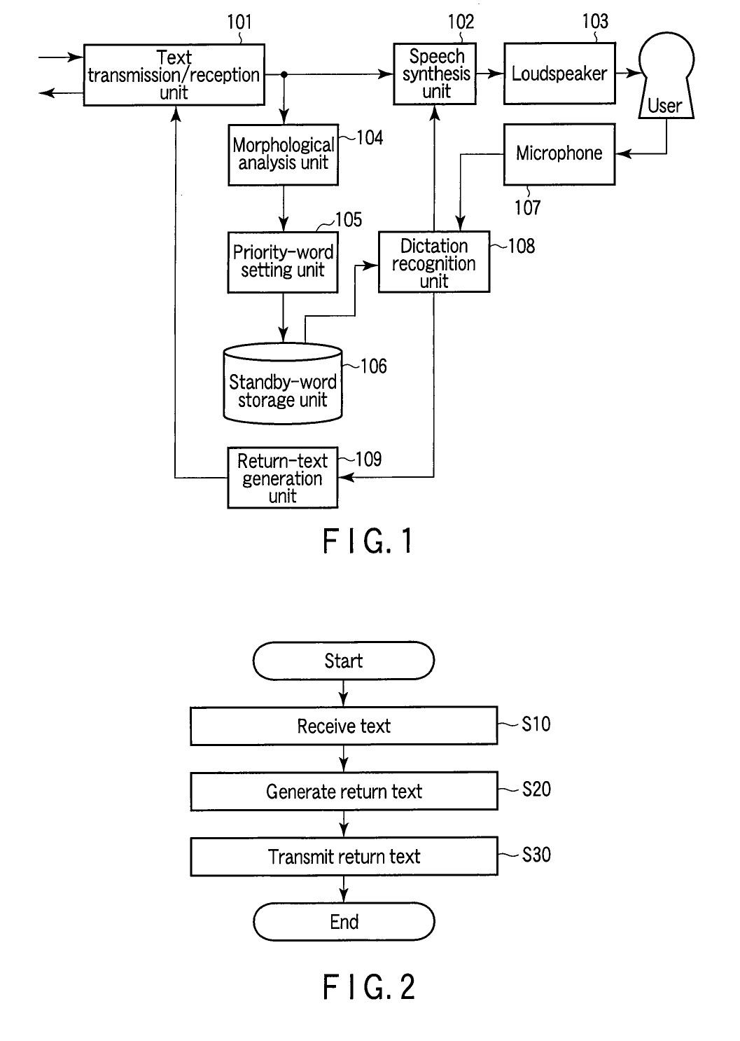

As shown in FIG. 1, a dialogue generation apparatus according to a first embodiment of the invention comprises a text transmission/reception unit 101, a speech synthesis unit 102, a loudspeaker 103, a morphological analysis unit 104, a priority-word setting unit 105, a standby-word storage unit 106, a microphone 107, a dictation recognition unit 108, and a return-text generation unit 109.

The text transmission/reception unit 101 receives text (hereinafter, just referred to as incoming text) from a person with whom the user is holding a dialogue (hereinafter, simply referred to as the dialogue partner) and transmits text (hereinafter, simply referred to as return text) to the dialogue partner. The text is transmitted and received via a wired network or a wireless network according to a specific communication protocol, such as a mail protocol. Various forms of the text can be considered according to dialogue means that realizes a dialogue between the user and the dialogue partner. The text may be, for example, electronic mail text, a chat message, or a message to be submitted to a BBS. When an image file, a sound file, or the like has been attached to incoming text, the text transmission/reception unit 101 may receive the file or attach the file to return text and transmits the resulting text. When the data attached to the incoming text is text data, the attached data may be treated in the same manner as incoming text. The text transmission/reception unit 101 inputs the incoming text to the speech synthesis unit 102 and morphological analysis unit 104.

The speech synthesis unit 102 performs a speech synthesis process of synthesizing specific speech data according to incoming text from the text transmission/reception unit 101, thereby converting the incoming text into speech data. The speech data synthesized by the speech synthesis unit 102 is presented to the user via the loudspeaker 103. The speech synthesis unit 102 and loudspeaker 103 subject such text as an error message input by the dictation recognition unit 108 to a similar process.

The morphological analysis unit 104 subjects the incoming text from the text transmission/reception unit 101 to a morphological analysis process. Specifically, by the morphological analysis process, the words constituting the incoming text are obtained and further reading information on the words, word class information, and linguistic information, including a fundamental form and a conjugational form, are obtained. The morphological analysis unit 104 inputs the result of the morphological analysis of the incoming text to the priority-word setting unit 105.

The priority-word setting unit 105 selects a word desirable for being recognized preferentially by the dictation recognition unit 108 explained later (hereinafter, just referred to as a priority word) from the morphological analysis result from the morphological analysis unit 104. It is desirable that a priority word should be a word highly likely to be included in the input speech from the user in response to the incoming text. For example, it may be a word that characterizes the contents of the incoming text. The priority-word setting unit 105 sets the selected priority word in the standby-word storage unit 106. A concrete selecting method and setting method for priority words will be will be explained later. In the standby-word storage unit 106, standby words serving as recognition candidates in a speech recognition process performed by the dictation recognition unit 108 described later have been stored. In the standby-word storage unit 106, general words have been stored cyclopedically as standby words.

Receiving the speech from the user, the microphone 107 inputs speech data to the dictation recognition unit 108. The dictation recognition unit 108 subjects the user's input speech received via the microphone 107 to a dictation recognition process. Specifically, the dictation recognition unit 108 converts the input speech into linguistic text composed of standby words on the basis of the acoustic similarity between the input speech and the standby words stored in the standby-word storage unit 106 and on the linguistic reliability. If having failed in speech recognition, the dictation recognition unit 108 creates a specific error message to inform the user of recognition failure and inputs the message to the speech synthesis unit 102. Furthermore, having succeeded in speech recognition, the dictation recognition unit 108 also inputs the result of speech recognition and a specific approval request message to the speech synthesis unit 102 to obtain the user's approval.

The return-text generation unit 109 generates return text on the basis of the speech recognition result from the dictation recognition unit 108. For example, the return-text generation unit 109 generates electronic mail, a chat message, or a message to be submitted to a BBS whose text is the speech recognition result. The return-text generation unit 109 inputs the generated return text to the text transmission/reception unit 101.

The processes carried out by the dialogue generation apparatus of FIG. 1 are roughly classified as shown in FIG. 2. First, the dialogue generation apparatus of FIG. 1 receives text (or incoming text) from the dialogue partner (step S10). Next, the dialogue generation apparatus of FIG. 1 presents the incoming text received in step S10 to the user, receives a voice response from the user, and generates return text on the basis of the result of recognizing the speech (step S20). The details of step S20 will be explained later. Finally, the dialogue generation apparatus transmits the return text generated in step S20 to the dialogue partner (step S30), which completes the process.

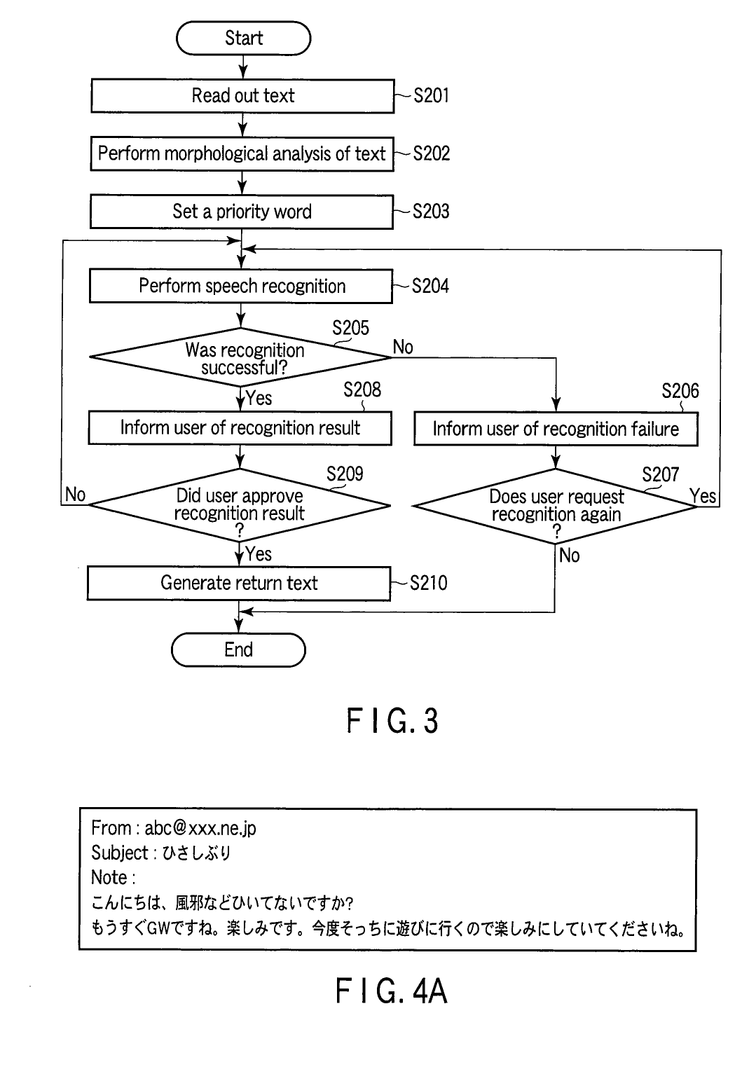

Hereinafter, the process of generating return-text of FIG. 2 will be explained with reference to FIG. 3.

First, the incoming text received by the text transmission/reception unit 101 is converted into speech data by the speech synthesis unit 102 and the speech data is read via the loudspeaker 103 (step S201).

The incoming text is subjected to morphological analysis by the morphological analysis unit 104 (step S202). Then, the priority-word setting unit 105 selects a priority word from the result of morphological analysis in step S202 and sets the word in the standby-word storage unit 106 (step S203). Here, a concrete example of a method of selecting a priority word and a method of setting a priority word at the priority-word setting unit 105 will be explained.

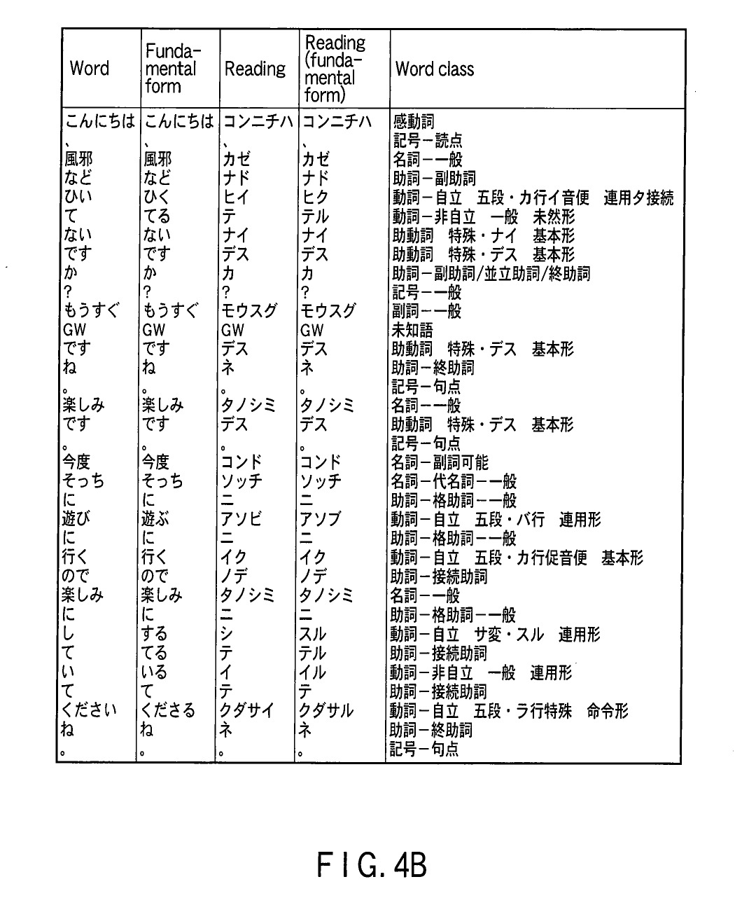

For example, the result of morphological analysis of incoming Japanese text shown in FIG. 4A is as shown in FIG. 4B. If the incoming text is Japanese text, the priority-word setting unit 105 determines that neither particles nor auxiliary verbs are words which characterize the contents of the incoming text and does not select these words as priority words. That is, the priority-word setting unit 105 selects words whose word classes are nouns, verbs, adjectives, adverbs, and exclamations as priority words from the result of morphological analysis. However, the priority-word setting unit 105 does not select a 1-character word as a priority word. In the case of a word that is not said independently, such as [symbol] or [symbol] the priority-word setting unit 105 concatenates them and selects the resulting word.

The morphological analysis unit 104 may be incapable of analyzing some proper nouns and special technical terms and obtaining linguistic information including word class information. The words the morphological analysis unit 104 cannot analyze are output as “unknown” in the morphological analysis result (e.g., “GW” in FIG. 4B). If the unknown is a proper noun or a special technical term, it can be considered to be a word that characterizes the contents of the incoming text. For example, a proper noun, such as a personal name or a place name, included in the incoming text is highly likely to be included again in the input speech from the user.

In the example of FIG. 4B, the priority-word setting unit 105 selects [symbol] [symbol] [symbol] “GW”, [symbol] [symbol] [symbol] [symbol] and [symbol] as priority words.

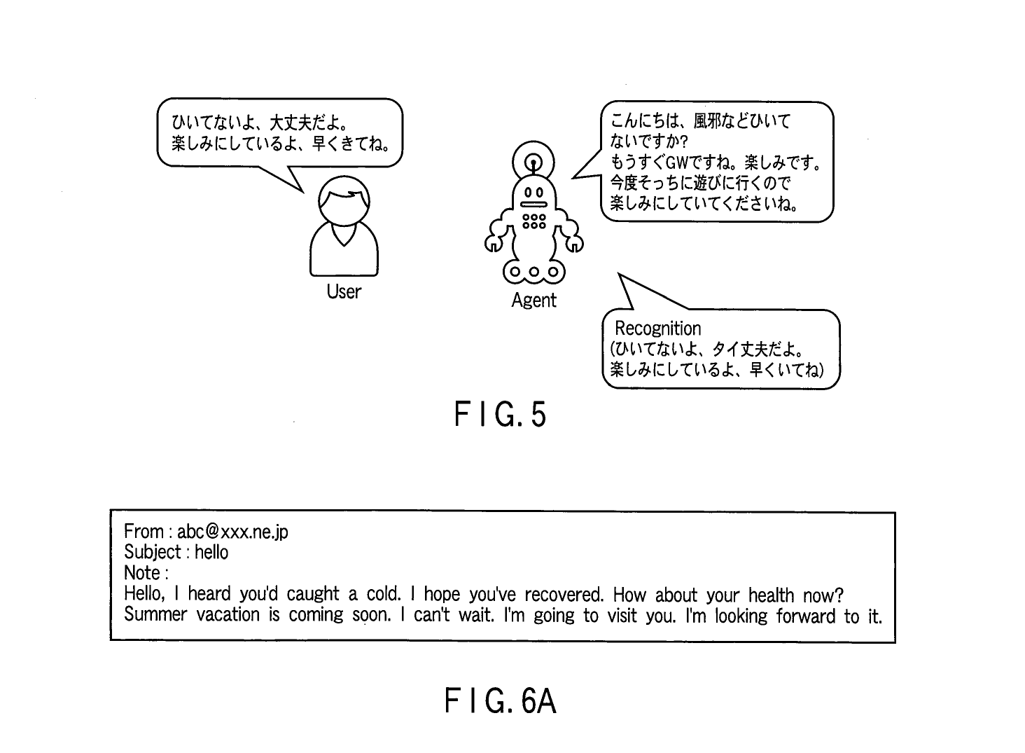

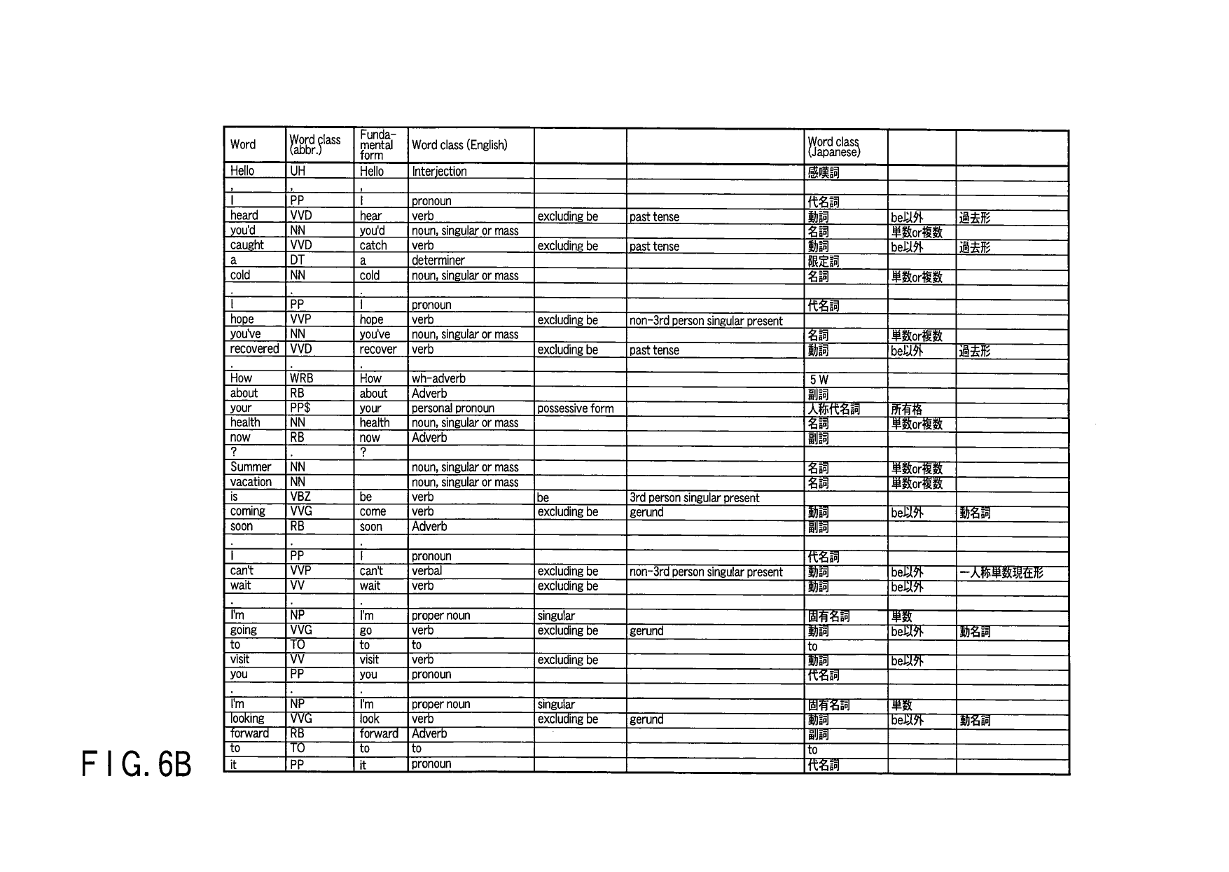

The result of morphological analysis of incoming English text shown in FIG. 6A is as shown in FIG. 6B. In FIG. 6B, word class information is specified by a specific symbol. If incoming text is English text, the priority-word setting unit 105 regards pronouns (I, you, it), “have” representing the perfect, articles (a, the), prepositions (about, to), interrogatives (how), and the verb “be” as words that do not characterize the contents of the incoming text and selects words other than these words as priority words.

The morphological analysis unit 104 may be incapable of analyzing some proper nouns and special technical terms and obtaining linguistic information including word class information. The words the morphological analysis unit 104 cannot analyze are output as “unknown” in the morphological analysis result. If the unknown is a proper noun or a special technical term, it can be considered to be a word that characterizes the contents of the incoming text. For example, a proper noun, such as a personal name or a place name, included in the incoming text is highly likely to be included again in the input speech from the user.

In the example of FIG. 6B, the priority-word setting unit 105 selects “hello”, “heard”, “caught”, “cold”, “hope”, “recovered”, “health”, “now”, “% summer”, “vacation”, “coming”, “soon”, “can't”, “wait”, “going”, “visit”, “looking”, and “forward” as priority words.

As described above, since general words have been registered cyclopedically in the standby-word storage unit 106, the priority-word setting unit 105 does not just add the selected priority words to the standby-word storage unit 106 but has to set priority words so that the dictation recognition unit 108 may recognize them preferentially. For example, suppose the dictation recognition unit 108 keeps the score of the acoustic similarity between the input speech from the user and the standby words and of the linguistic reliability and outputs the top-level standby word as the recognition result. In this example, in a speech recognition process carried out by the dictation recognition unit 108, the priority-word setting unit 105 performs setting so as to add a specific value to the score calculated for a priority word or, if the priority word is included in upper-level candidates (e.g., the top five score candidates), outputs the priority word as the recognition result (i.e., treats the priority word as the top-level-score standby word).

After finishing the processes in steps S201 to S203, the dialogue generation apparatus of FIG. 1 waits for the speech from the user. The process in step S201 and the processes in steps S202 and S203 may be carried out in reverse order or in parallel. Having received the speech from the user via the microphone 107, the dictation recognition unit 108 performs a speech recognition process (step S204). If the speech from the user has stopped for a specific length of time, the dictation recognition unit 108 terminates the speech recognition process.

In step S204, the dictation recognition unit 108 does not necessarily succeed in speech recognition. For example, when the speech of the user is unclear or when environmental sound is loud, the dictation recognition unit 108 might fail in speech recognition. The dictation recognition unit 108 proceeds to step S208 if having succeeded in speech recognition, and proceeds to step S206 if having failed in speech recognition (step S205).

In step S206, the dictation recognition unit 108 inputs to the speech synthesis unit 102 a specific error message, such as “The speech hasn't been recognized. Would you try again?” The error message is converted into speech data by the speech synthesis unit 102. The speech data is presented to the user via the loudspeaker 103. With the speech representation of the error message, the user can make sure that the speech recognition by the dictation recognition unit 108 has failed. If the user requests the error message be recognized again, the process returns to step S204. If not, the dictation recognition unit 108 informs the user via the speech synthesis unit 102 and loudspeaker 103 of the message that the text could not be recognized, and terminates the process (step S207). The mode in which the user requests re-recognition is not particularly limited. For example, the user requests re-recognition by saying “Yes” or pressing a specific button provided on the dialogue generation apparatus.

In step S208, the dictation recognition unit 108 inputs to the speech synthesis unit 102 a specific recognition request message, such as “Is this okay? Would you like to recognize the message again?”, together with the speech recognition result in step S205. The speech recognition result and approval request message are converted into speech data by the speech synthesis unit 102. The speech data is presented to the user via the loudspeaker 103. If the user has given approval in response to the approval request message, the process goes to step S210. If not, the process returns to step S204 (step S209). The mode in which the user approves the speech recognition result is not particularly limited. For example, the user approves the speech recognition result by saying “Yes” or pressing a specific button provided on the dialogue generation apparatus. In step S210, the return-text generation unit 109 generates return text on the basis of the speech recognition result approved by the user in step S209 and terminates the process.

FIG. 5 shows an example of using the dialogue generation apparatus of FIG. 1 in connection with the incoming text shown in FIG. 4A. Although in FIG. 5 and the other figures showing examples of use, the dialogue generation apparatus is illustrated as a robotic terminal referred to as an agent, the form of the dialogue generation apparatus is not limited to such a robotic one. The incoming text of FIG. 4A is read out by the dialogue generation apparatus of FIG. 1. Suppose the user said in response to the incoming text read out,

[symbol]

[symbol]

[symbol]

[symbol]

[symbol]

As described above, since on the basis of the incoming text of FIG. 4A, the priority-word setting unit 105 sets [symbol] [symbol] “GW”, [symbol] [symbol] [symbol] [symbol] and [symbol] as priority words, these words are recognized preferentially by the dictation recognition unit 108. The priority words characterize the contents of the incoming text. It is desirable that the priority words should be recognized correctly even in the return text.

In FIG. 5, [symbol] [symbol] [symbol] [symbol] [symbol] are obtained as the result of speech recognition of the user's speech described above. In the actual speech recognition result, [symbol] (“da,” “i,” “jo,” “bu”) which is not a priority word might have been recognized erroneously as [symbol] (“ta”, “i”, “jo”, “bu”).” [symbol] (“ki”, “te”, “ne”) might have been recognized erroneously as [symbol] (“i”, “te”, “ne”)”. However, [symbol] and [symbol] set as priority words can be expected to be recognized with a high degree of certainty. That is, with the dialogue generation apparatus of FIG. 1, suitable return text can be generated for the incoming text on the basis of the user's speech without impairing the degree of freedom of dialogue.

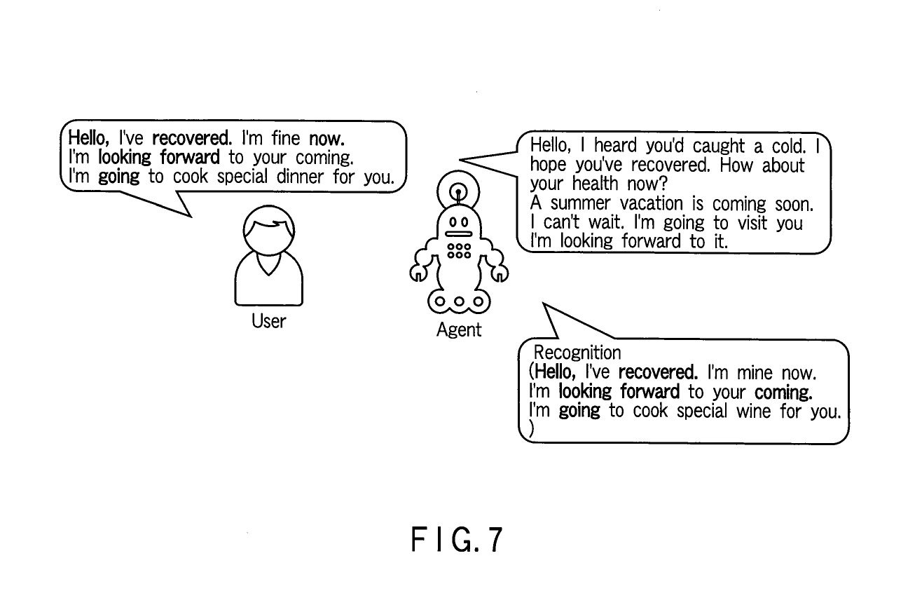

FIG. 7 shows an example of using the dialogue generation apparatus of FIG. 1 in connection with the incoming text shown in FIG. 6A. The incoming text of FIG. 6A is read out by the dialogue generation apparatus of FIG. 1. Suppose the user said in response to the incoming text read out, “Hello, I've recovered. I'm fine now. I'm looking forward to your coming. I'm going to cook special dinner for you.”

As described above, since on the basis of the incoming text of FIG. 6A, the priority-word setting unit 105 sets “hello”, “heard”, “caught”, “cold”, “hope”, “recovered”, “health”, “now”, “summer, “vacation”, “coming”, “soon”, “can't”, “wait”, “going”, “visit”, “looking”, and “forward” as priority words, these words are recognized preferentially by the dictation recognition unit 108. The priority words characterize the contents of the incoming text. It is desirable that the priority words should be recognized correctly even in the return text.

In FIG. 7, “Hello, I've recovered. I'm mine now. I'm looking forward to your coming. I'm going to cook special wine for you.” are obtained as the result of speech recognition of the user's speech described above. In the actual speech recognition result, “fine” which is not a priority word might have been recognized erroneously as “mine.” In addition, “dinner” might have been recognized erroneously as “wine”. However, “hello”, “recovered”, “now”, “coming”, “going”, “looking”, and “forward” set as priority words can be expected to be recognized with a high degree of certainty. That is, with the dialogue generation apparatus of FIG. 1, suitable return text can be generated for the incoming text without impairing the degree of freedom of dialogue.

As described above, the dialogue generation apparatus of the first embodiment selects priority words that characterize the contents of the incoming text from the words obtained by the morphological analysis of the incoming text and recognizes the priority words preferentially when performing speech recognition of the user's speech in response to the incoming text. Accordingly, with the dialogue generation apparatus of the first embodiment, suitable return text can be generated in response to the incoming text on the basis of the user's speech without impairing the degree of freedom of dialogue.

### Second Embodiment

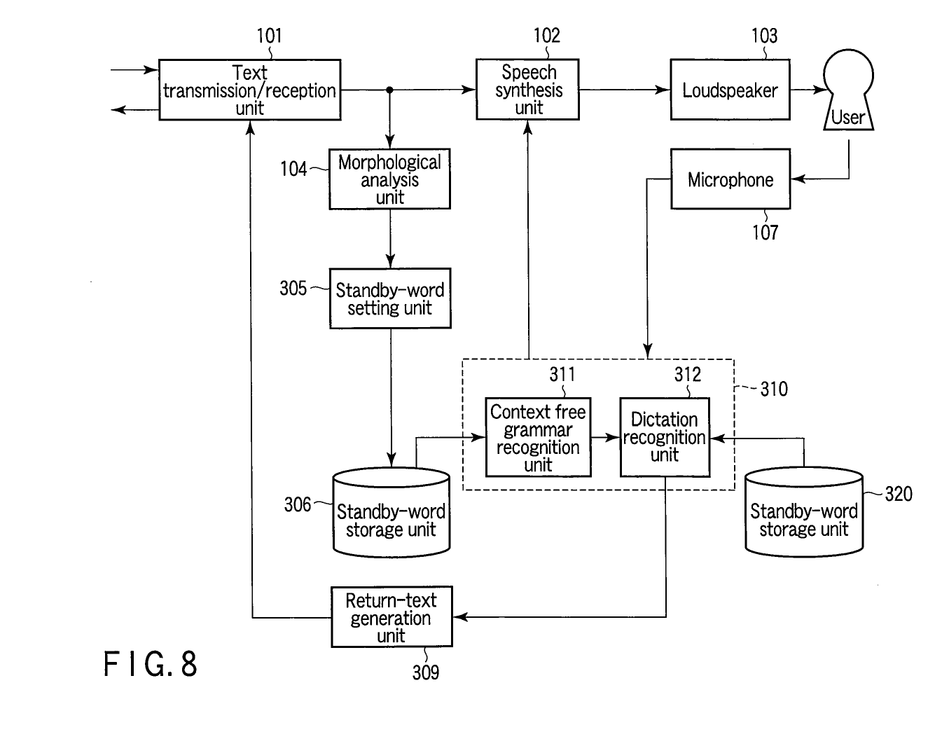

As shown in FIG. 8, a dialogue generation apparatus according to a second embodiment of the invention comprises a text transmission/reception unit 101, a speech synthesis unit 102, a loudspeaker 103, a morphological analysis unit 104, a standby-word setting unit 305, a standby-word storage unit 306, a microphone 107, a return-text generation unit 309, a speech recognition unit 310, and a standby-word storage unit 320. In the explanation below, the same parts in FIG. 8 as those in FIG. 1 are indicated by the same reference numbers. The explanation will be given, centering on what differs from those of FIG. 1.

From the morphological analysis result from the morphological analysis unit 104, the standby-word setting unit 305 selects standby words to serve as recognition candidates in a speech recognition process performed by a context-free grammar recognition unit 311 explained later. It is desirable that the standby words in the context-free grammar recognition unit 311 should be words highly likely to be included in the input speech from the user in response to the incoming text. As an example, the standby words may be words that characterize the contents of the incoming text. The standby-word setting unit 305 sets the selected standby words in the standby-word storage unit 320. Suppose the standby-word setting unit 305 selects a standby word as the priority-word setting unit 105 selects a priority word. Moreover, the standby-word setting unit 305 may subject the standby-word storage unit 320 to a priority-word setting process similar to that performed by the priority-word setting unit 105. In the standby-word storage unit 306, the standby words set by the standby-word setting unit 305 are stored.

The speech recognition unit 310 includes the context-free grammar recognition unit 311 and a dictation recognition unit 312.

The context-free grammar recognition unit 311 subjects the input speech from the user received via the microphone 107 to a context-free grammar recognition process. Specifically, the context-free grammar recognition unit 311 converts a part of the input speech into standby words on the basis of the acoustic similarity between the input speech and the standby words stored in the standby-word storage unit 306 and on the linguistic reliability. The standby words in the context-free grammar recognition unit 311 are limited to those set in the standby-word storage unit 306 by the standby-word setting unit 305. Accordingly, the context-free grammar recognition unit 311 can recognize the standby words with a high degree of certainty.

The dictation recognition unit 312 subjects the input speech from the user received via the microphone 107 to a dictation recognition process. Specifically, the dictation recognition unit 312 converts the input speech into language text composed of standby words on the basis of the acoustic similarity between the input speech and the standby words stored in the standby-word storage unit 320 and on the linguistic reliability.

The speech recognition unit 310 outputs to the return-text generation unit 309 the result of speech recognition obtained by putting together the context-free grammar recognition result from the context-free grammar recognition unit 311 and the dictation recognition result from the dictation recognition unit 312. Specifically, the speech recognition result output from the speech recognition unit 310 is such that the context-free grammar recognition result from the context-free grammar recognition unit 311 is complemented by the dictation recognition result from the dictation recognition unit 312.

If having failed in speech recognition, the speech recognition unit 310 generates a specific error message to inform the user of recognition failure and inputs the message to the speech synthesis unit 102. Even if having succeeded in speech recognition, the speech recognition unit 310 inputs the speech recognition result to the speech synthesis unit 102 to get the user's approval.

In the standby-word storage unit 320, standby words to serve as recognition candidates in the speech recognition process performed by the dictation recognition unit 312 have been stored. The standby-word storage unit 320 stores general words as standby words cyclopedically.

The return-text generation unit 309 generates return text on the basis of the speech recognition result from the speech recognition unit 310. For example, the return-text generation unit 309 generates electronic mail, a chat message, or a message to be submitted on a BBS whose text is the speech recognition result. The return-text generation unit 309 inputs the generated return text to the text transmission/reception unit 101.

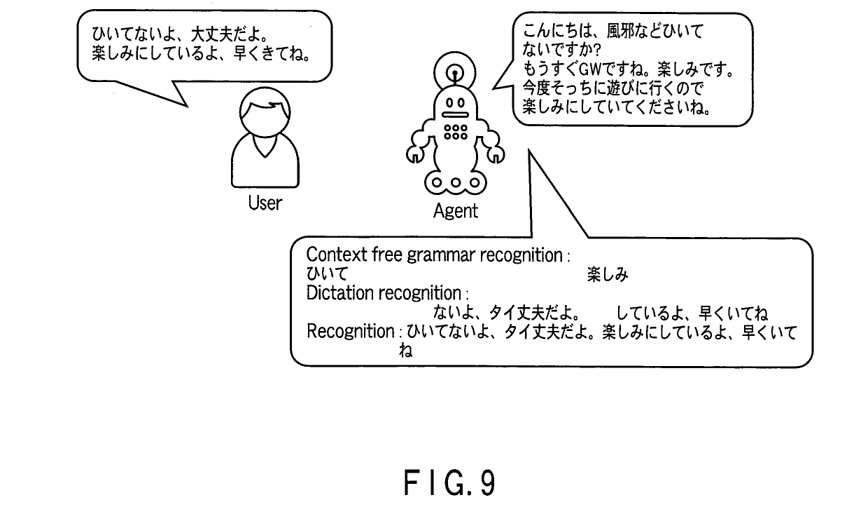

FIG. 9 shows an example of using the dialogue generation apparatus of FIG. 8 in connection with the incoming text shown in FIG. 4A. The incoming text of FIG. 4A is read out by the dialogue generation apparatus of FIG. 8. Suppose the user said in response to the incoming text read out,

[symbol]

[symbol]

[symbol]

[symbol]

[symbol]

As described above, since the standby-word setting unit 305 sets [symbol] [symbol] [symbol] “GW”, [symbol] [symbol] [symbol] [symbol] [symbol] and [symbol] as standby words in the context-free grammar recognition unit 311 on the basis of the incoming text of FIG. 4A, these words are recognized by the context-free grammar recognition unit 311 with a high degree of certainty. The standby words characterize the contents of the incoming text. It is desirable that they should be recognized correctly even in the return text.

In FIG. 9, [symbol] and [symbol] are obtained as the context-free grammar recognition result for the user's speech. Moreover, [symbol] [symbol] [symbol] [symbol] [symbol] are obtained as the dictation recognition result that complements the context-free grammar recognition result. Accordingly, both are put together, giving the following final speech recognition result: [symbol] [symbol] [symbol] [symbol] [symbol] As described above, in the actual speech recognition result, [symbol] (“da”, “i”, “jo” “bu”)” which is not a standby word in the context-free grammar recognition unit 311 might have been recognized erroneously as [symbol] (“ta “i”, “jo”, “bu”)”. [symbol] [symbol] (“ki”, “te”, “ne”) might have been recognized erroneously as [symbol] (“i”, “te”, “ne”)”. However, [symbol] [symbol] and [symbol] set as standby words in the context-free grammar recognition unit 311 can be expected to be recognized with a high degree of certainty. That is, with the dialogue generation apparatus of FIG. 8, suitable return text can be generated for the incoming text on the basis of the user's speech without impairing the degree of freedom of dialogue.

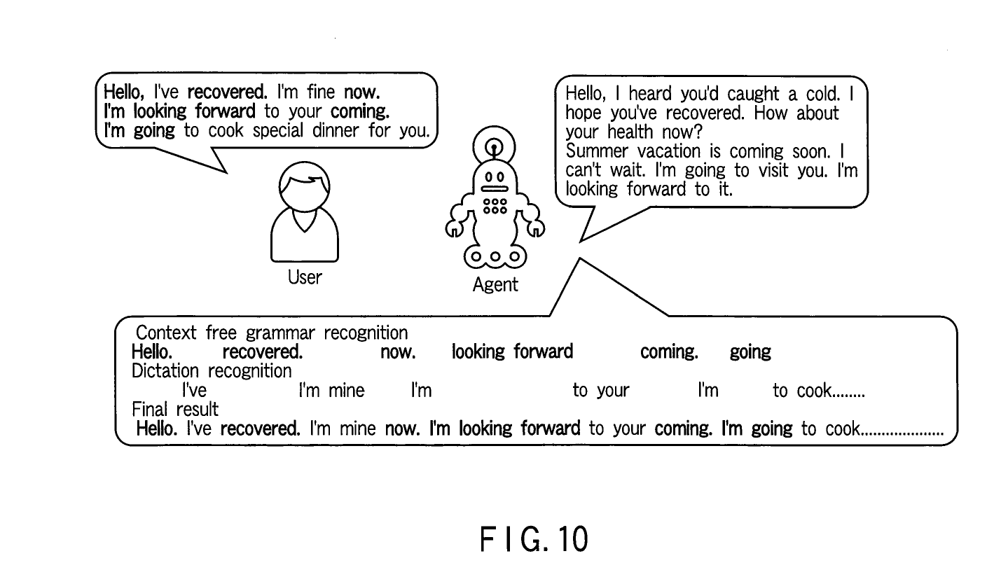

FIG. 10 shows an example of using the dialogue generation apparatus of FIG. 1 in connection with the incoming text shown in FIG. 6A. The incoming text of FIG. 6A is read out by the dialogue generation apparatus of FIG. 8. Suppose the user said in response to the incoming text read out, “Hello, I've recovered. I'm fine now. I'm looking forward to your coming. I'm going to cook special dinner for you.”

As described above, since on the basis of the incoming text of FIG. 6A, the standby-word setting unit 305 sets “hello”, “heard”, “caught”, “cold”, “hope”, “recovered”, “health”, “now”, “summer”, “vacation”, “coming”, “soon”, “can't”, “wait”, “going”, “visit”, “looking”, and “forward” as standby words, these words are recognized by the context-free grammar recognition unit 311 with a high degree of certainty. The standby words characterize the contents of the incoming text. It is desirable that the standby words should be recognized correctly even in the return text.

In FIG. 10, “Hello”, “recovered.”, “now.”, “looking forward”, “coming.”, and “going” are obtained as the context-free grammar recognition result for the user's speech. Moreover, “(Hello,) I've (recovered.) I'm mine (now.) I'm (looking forward) to your (coming.) I'm (going) to cook . . . ” are obtained as the dictation recognition result that complements the context-free grammar recognition result. Accordingly, both are put together, giving the final speech recognition result: “Hello, I've recovered. I'm mine now. I'm looking forward to your coming. I'm going to cook . . . ” In the actual speech recognition result, “fine” which is not a standby word in the context-free grammar recognition unit 311 might have been recognized erroneously as “mine”. However, “Hello,”, “recovered.”, “now.”, “looking forward”, “coming.”, and “going” set as standby words in the context-free grammar recognition unit 311 can be expected to be recognized with a high degree of certainty. That is, with the dialogue generation apparatus of FIG. 8, suitable return text can be generated for the incoming text on the basis of the user's speech without impairing the degree of freedom of dialogue.

As described above, the dialogue generation apparatus of the second embodiment combines the context-free grammar recognition process and the dictation recognition process and uses priority words of the first embodiment as standby words in the context-free grammar recognition process. Accordingly, with the dialogue generation apparatus of the second embodiment, standby words corresponding to the priority words can be recognized with a high degree of certainty in the context-free grammar recognition unit process.

### Third Embodiment

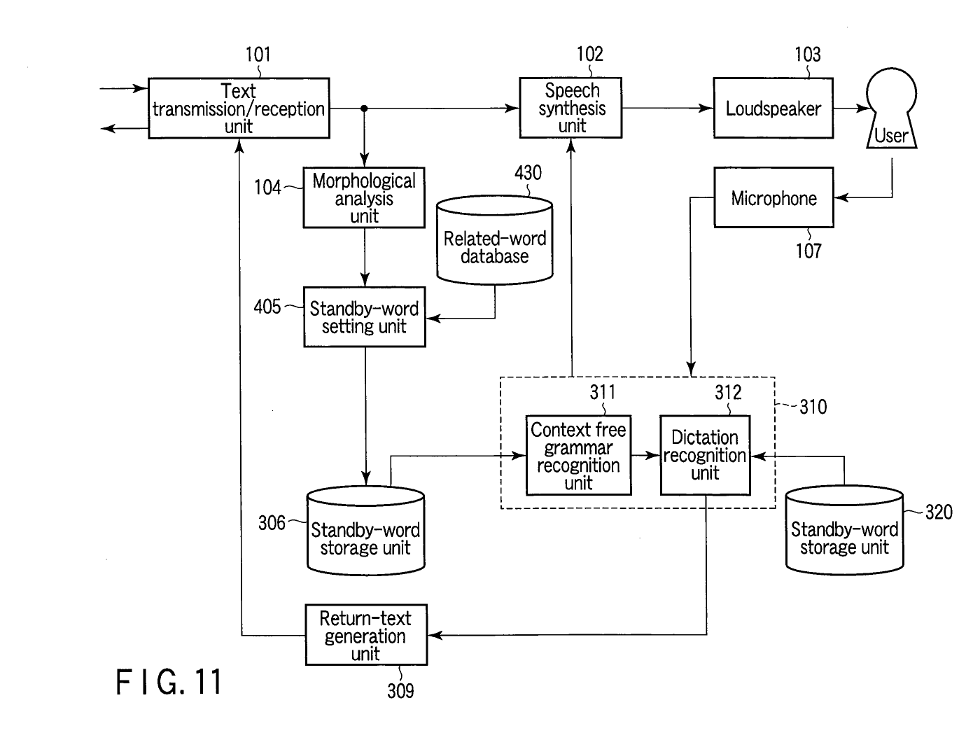

As shown in FIG. 11, a dialogue generation apparatus according to a third embodiment of the invention is such that the standby-word setting unit 305 is replaced with a standby-word setting unit 405 and a related-word database 430 is further provided in the dialogue generation apparatus shown in FIG. 8. In the explanation below, the same parts in FIG. 11 as those in FIG. 8 are indicated by the same reference numbers. The explanation will be given, centering on what differs from those of FIG. 8.

In the related-word database 430, the relation between each word and other words, specifically, related words in connection with each word, has been written. A concrete writing method is not particularly limited. For instance, related words are written using OWL (Web Ontology Language), one of the markup languages.

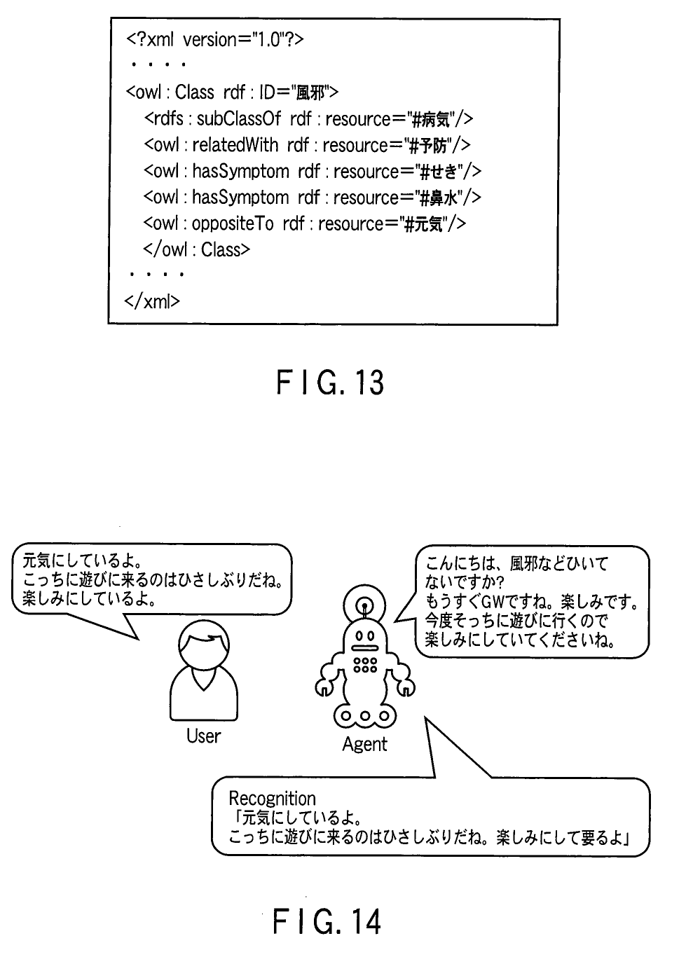

For example, in the example of FIG. 13, [symbol] [symbol] [symbol] [symbol] and [symbol] have been written as the related words of [symbol] Specifically, it has been written that [symbol] belongs to class [symbol] [symbol] is related to the word [symbol] [symbol] has symptoms of [symbol] and [symbol] and [symbol] is antonymous with

[symbol]

Furthermore, in the example of FIG. 15, “prevention”, “cough”, “running nose”, and “fine” have been written as the related words of “cold”. Specifically, it has been written that “cold” belongs to class “disease”, “cold” is related to “prevention”, “cold” has symptoms of “cough” and “running nose”, and “cold” is antonymous with “fine”.

Like the standby-word setting unit 305, the standby-word setting unit 405 sets the standby word of the context-free grammar recognition unit 311 in the standby-word storage unit 306. Moreover, the standby-word setting unit 405 retrieves the related words of the standby word from the related-word database 430 and sets also the related words as standby words in the standby-word storage unit 306.

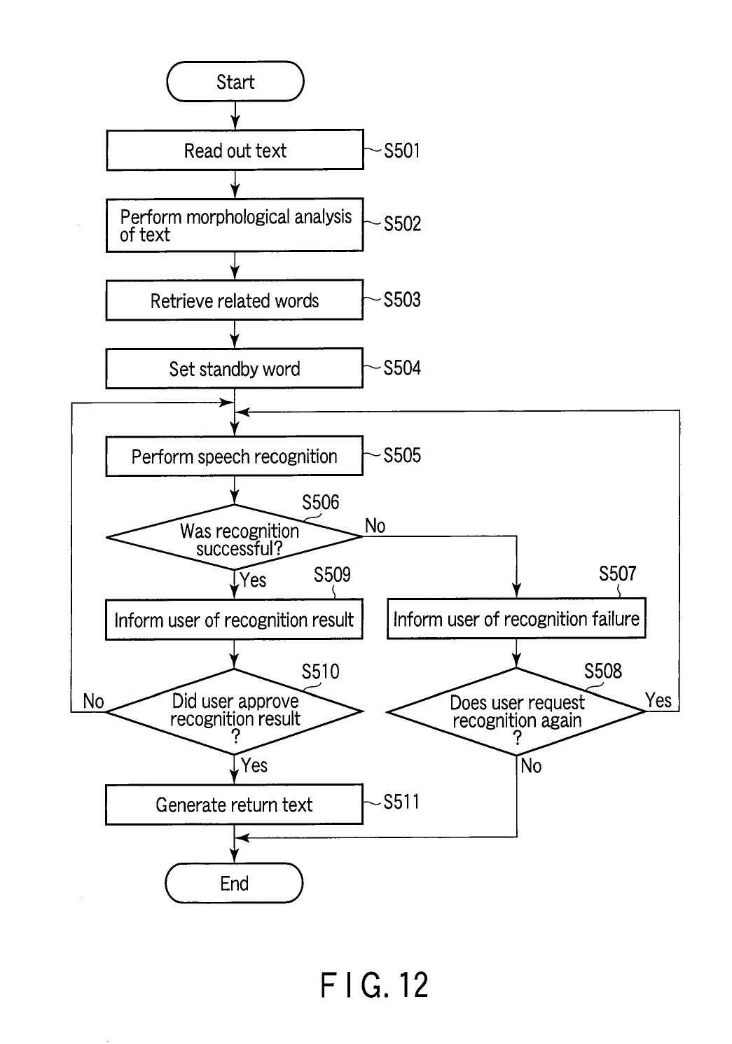

Hereinafter, a return-text generation process performed by the dialogue generation apparatus of FIG. 11 will be explained in detail with reference to FIG. 12.

First, the incoming text received by the text transmission/reception unit 101 is converted into speech data by the speech synthesis unit 102. The speech data is read out by the loudspeaker 103 (step S501).

Moreover, the incoming text is subjected to morphological analysis by the morphological analysis unit 104 (step S502). Next, the standby-word setting unit 405 selects the standby word of the context-free grammar recognition unit 311 from the morphological analysis result in step S502 and retrieves the related words of the standby word from the related-word database 430 (step S503). Then, the standby-word setting unit 405 sets the standby word selected from the morphological analysis result in step S502 and the related words of the standby word in the standby-word storage unit 306 (step S504).

After the processes in steps S501 to S504 have been terminated, the dialogue generation apparatus of FIG. 11 waits for the user's speech. The process in step S501 and the processes in steps S502 to S504 may be carried out in reverse order or in parallel. Having received the speech from the user via the microphone 107, the speech recognition unit 310 performs a speech recognition process (step S503). When the user's speech has stopped for a specific length of time, the speech recognition unit 310 terminates the speech recognition process.

If in step S505, the speech recognition unit 310 has succeeded in speech recognition, the process proceeds to step S509. If not, the process proceeds to step S507 (step S506).

In step S507, the speech recognition unit 310 inputs a specific error message to the speech synthesis unit 102. The error message is converted into speech data by the speech synthesis unit 102. The speech data is presented to the user via the loudspeaker 103. With the speech representation of the error message, the user can make sure that the speech recognition by the speech recognition unit 310 has failed. If the user requests the error message be recognized again, the process returns to step S505. If not, the speech recognition unit 310 informs the user via the speech synthesis unit 102 and loudspeaker 103 of the message that the text could not be recognized, and terminates the process (step S508).

In step S509, the speech recognition unit 310 inputs to the speech synthesis unit 102 a specific approval request message together with the speech recognition result in step S506. The speech recognition result and approval request message are converted into speech data by the speech synthesis unit 102. The speech data is presented to the user via the loudspeaker 103. If the user has given approval in response to the approval request message, the process goes to step S511. If not, the process returns to step S505 (step S510). In step S511, the return-text generation unit 309 generates return text on the basis of the speech recognition result approved by the user in step S510 and terminates the process.

FIG. 14 shows an example of using the dialogue generation apparatus of FIG. 11. In FIG. 14, the incoming text is [symbol] [symbol] [symbol] [symbol] [symbol] GW [symbol] [symbol] [symbol] [symbol] [symbol] [symbol] The standby-word setting unit 405 selects the standby word of the context-free grammar recognition unit 311 from the result of morphological analysis of the incoming text and retrieves the related words of the standby word from the related-word database 430. Suppose the following related words have been obtained as a result of searching the related-word database 430 and set in the standby-word storage unit 306:

[symbol]

[symbol]

[symbol]

[symbol]

[symbol]

[symbol]

[symbol]

[symbol]

[symbol]

[symbol]

[symbol]

“GW”:

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

In FIG. 14, the user's input speech in response to the incoming text is [symbol] [symbol] [symbol] [symbol] [symbol] Since in the user's speech, [symbol] [symbol] [symbol] [symbol] and [symbol] have been set in the standby-word storage unit 306, the context-free grammar recognition unit 311 recognizes them with a high degree of certainty. For example, as shown in FIG. 14, the result of speech recognition of the user's speech is as follows:

[symbol]

[symbol]

[symbol]

[symbol]

[symbol]

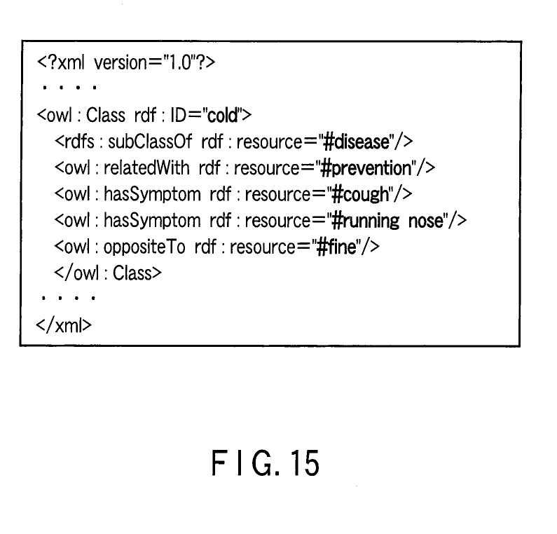

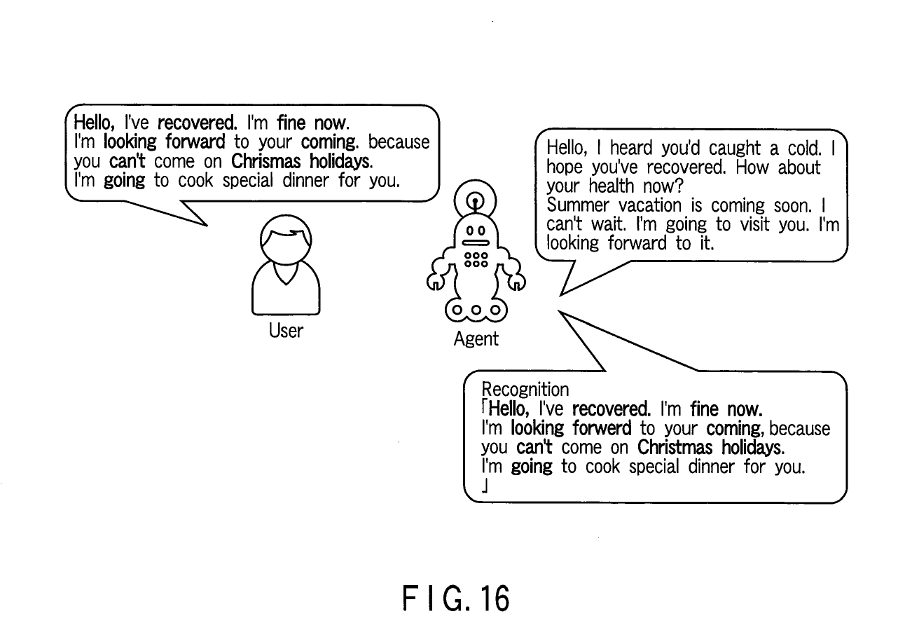

FIG. 16 shows another example of using the dialogue generation apparatus of FIG. 11. In FIG. 16, the incoming text is “Hello, I heard you'd caught a cold. I hope you've recovered. How about your health now? The summer vacation is coming soon. I can't wait. I'm going to visit you. I'm looking forward to it.” The standby-word setting unit 405 selects the standby word of the context-free grammar recognition unit 311 from the result of morphological analysis of the incoming text and retrieves the related words of the standby word from the related-word database 430. Suppose the following related words have been obtained as a result of searching the related-word database 430 and set in the standby-word storage unit 306:

“hello”: “good morning”, “good evening”, “good night”, “good bye”

“cold”: “prevention”, “cough”, “running nose”, “fine”

“summer”: “spring”, “fall”, “autumn”, “winter”, “Christmas”

“vacation”: “holiday”, “weekend”, “weekday”

In FIG. 16, the user's input speech in response to the incoming text is “Hello, I've recovered. I'm fine now. I'm looking forward to your coming, because you can't come on Christmas holidays. I'm coming to cook special dinner for you.” Since in the user's speech, “hello”, “recovered”, “fine”, “now”, “looking”, “forward”, “can't”, “Christmas”, “holiday”, and “going” have been set in the standby-word storage unit 306, the context-free grammar recognition unit 311 recognizes them with a high degree of certainty. For example, as shown in FIG. 16, the result of speech recognition of the user's speech is as follows: “Hello, I've recovered. I'm fine now. I'm looking forward to your coming, because you can't come on Christmas holidays. I'm coming to cook special dinner for you.”

As described above, the dialogue generation apparatus of the third embodiment uses the standby words selected from the words obtained by morphological analysis of the incoming text and the related words of the standby words as standby words in the context-free grammar recognition process. Accordingly, with the dialogue generation apparatus of the third embodiment, even when a word is not included in the incoming text, if it is one of the related words, it can be recognized with a high degree of certainty in the context-free grammar recognition process. Therefore, the degree of freedom of dialogue can be improved further.

### Fourth Embodiment

The dialogue generation apparatus according to each of the first to third embodiments has been so configured that the apparatus reads out all of the incoming text and then receives the user's speech. However, when the incoming text is relatively long, it is difficult for the user to comprehend the contents of the entire text and therefore the user may forget the contents of the beginning part of the text. Moreover, since the number of words set as priority words or standby words increases, the recognition accuracy deteriorates. Taking these problems into consideration, it is desirable that the incoming text should be segmented in suitable units, the segmented text items then be presented to the user, and the user's speech be received. Accordingly, a dialogue generation apparatus according to a fourth embodiment of the invention is such that a text segmentation unit 850 (not shown) is provided in a subsequent stage of the text transmission/reception unit 101 in the dialogue generation apparatus in each of the first to third embodiments.

The text segmentation unit 850 segments the incoming text according to a specific segmentation rule and inputs the segmented text items sequentially to the morphological analysis unit 104 and speech synthesis unit 102. The segmentation rule may be, for example, to segment the incoming text in sentences or in linguistic units larger than sentences (e.g., topics). When the incoming text is segmented in topic units, the text is segmented on the basis of the presence or absence of a linefeed or of a representation of topic change. The representation of topic change includes, for example, [symbol] [symbol] and [symbol] in Japanese. In English, it includes, for example, “By the way”, “Well”, and “Now.” If the incoming text includes an interrogative sentence, the segmentation rule may be to convert the interrogative sentence into segmented text items. An interrogative sentence can be detected on the basis of, for example, the presence or absence of “?” or an interrogative word or of whether the sentence end is interrogative.

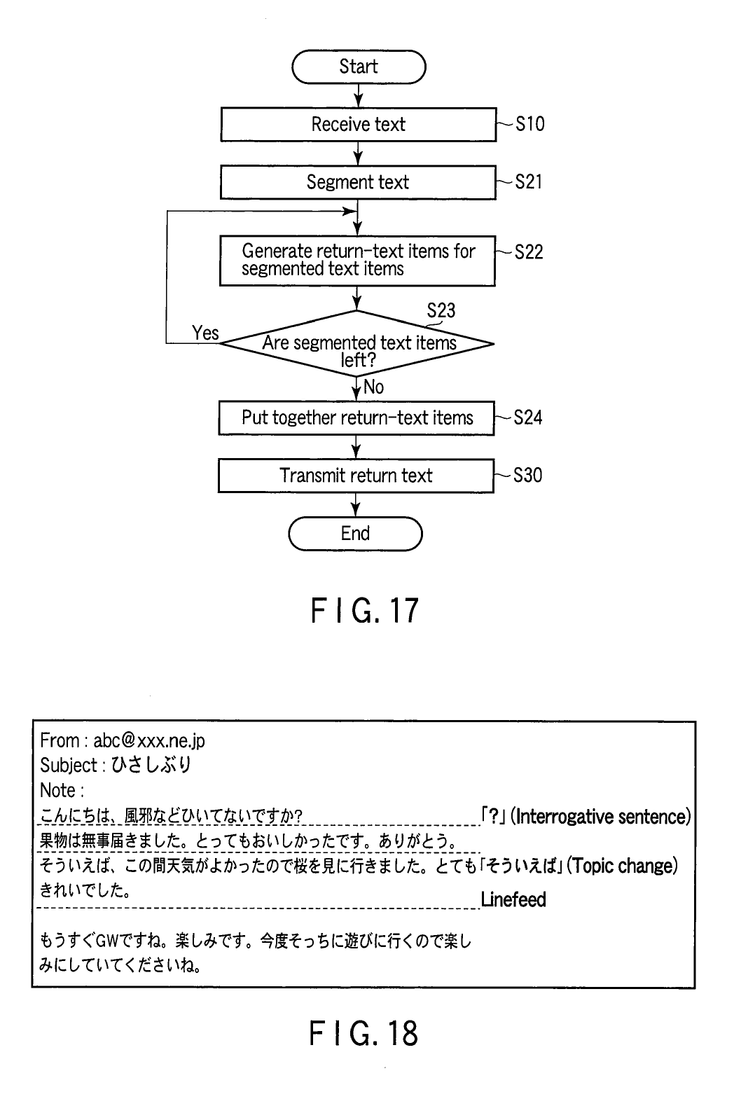

The dialogue generation apparatus according to each of the first to third embodiments performs the processes according to the flowchart of FIG. 2, whereas the dialogue generation apparatus of the fourth embodiment carries out the processes according to the flowchart of FIG. 17. That is, step S20 of FIG. 2 is replaced with steps S21 to S24 in FIG. 17.

In step S21, the text segmentation unit 850 segments the incoming text as described above. Next, the process of generating return text for the segmented text items produced in step S21 is carried out (step S22). The process in step S22 is the same as in step S20, except that the process unit is a segmented text item, not the entire incoming text.

If segmented text items not subjected to the process in step S22 are left, the next segmented text item is subjected to the process in step S22. If not, the process proceeds to step S24. In step S24, the return-text generation unit 309 puts together return-text items generated in segmented text units.

FIG. 18 shows an example of the segmentation of the following incoming text:

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol] GW [symbol] [symbol] [symbol] [symbol] [symbol] [symbol] Since the text segmentation unit 850 can detect “?” indicating an interrogative sentence by searching the incoming text sequentially from the beginning, the unit 850 outputs [symbol] [symbol] [symbol] [symbol] ?” as a first segmented text item. Next, since the text segmentation unit 850 can detect [symbol] representing a topic change in the remaining part of the incoming text, the unit 850 outputs [symbol] [symbol] [symbol] [symbol] [symbol] ” second segmented item. Next, since the text segmentation unit 850 can detect a linefeed in the remaining part of the incoming text, the unit 850 outputs [symbol] [symbol] [symbol] [symbol] [symbol] [symbol] as a third segmented item. Finally, the text segmentation unit 850 outputs [symbol] [symbol] GW [symbol] [symbol] [symbol] [symbol] [symbol] [symbol] the remaining part of the incoming text, as a fourth segmented text item.

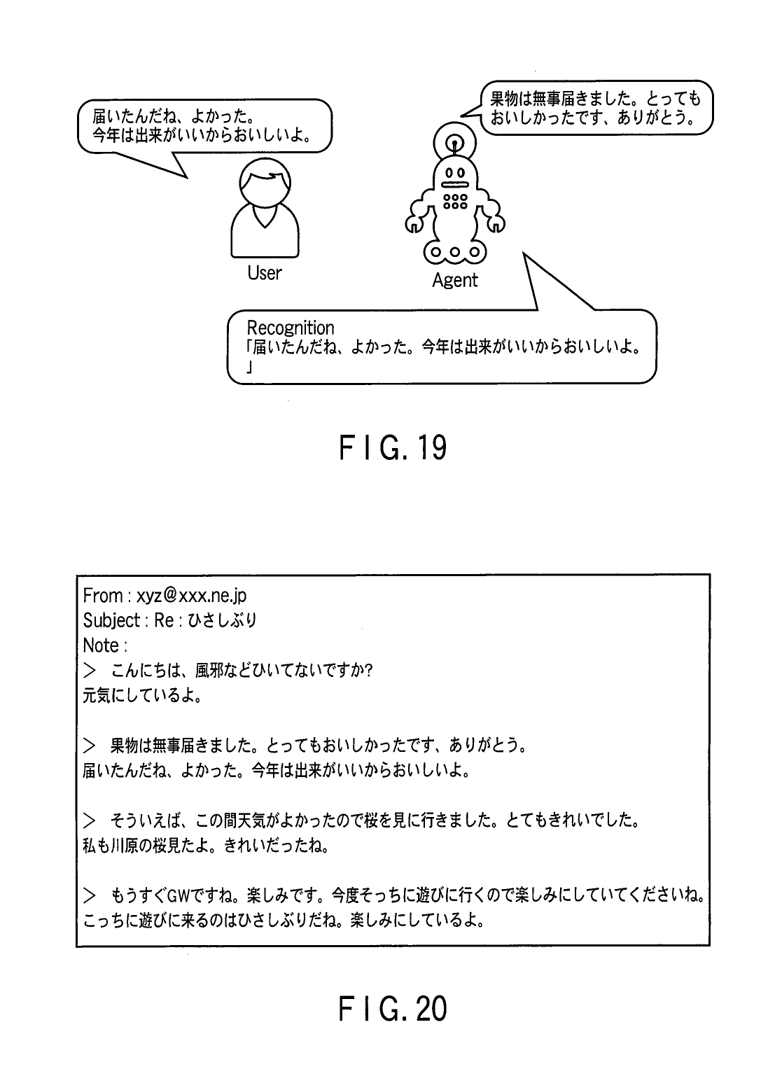

FIG. 19 shows the way return text is generated for the second segmented text item. In this way, return text is generated sequentially for each of the first to fourth segmented text items. FIG. 20 shows the result of putting together the return-text items for the first to fourth segmented text items. In FIG. 20, the first to fourth segmented text items have been quoted and return text has been put together in a thread form. When the return text is displayed in a thread form, the dialogue partner can comprehend the contents of the return text more easily than when the individual return-text items are simply put together.

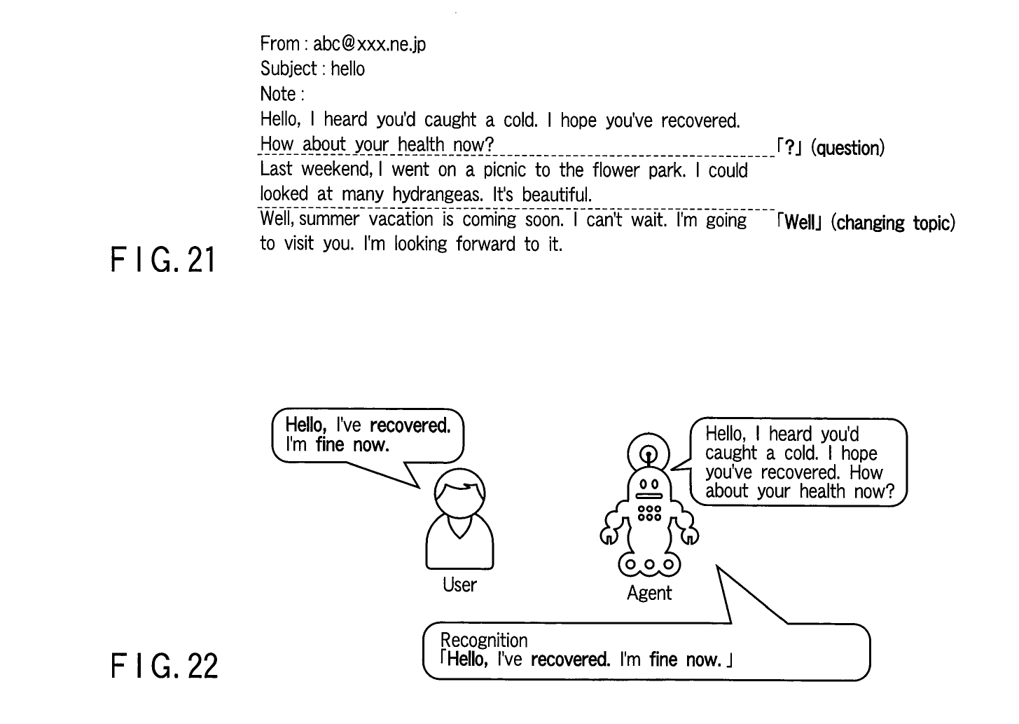

FIG. 21 shows an example of the segmentation of the following incoming text: “Hello, I heard you'd caught a cold. I hope you've recovered. How about you health now? Last weekend, I went on a picnic to the flower park. I could look at many hydrangeas. It's beautiful. Well, summer vacation is coming soon. I can't wait. I'm going to visit you. I'm looking forward to it.” First, since the text segmentation unit 850 can detect “?” indicating an interrogative sentence by searching the incoming text sequentially from the beginning, the unit 850 outputs “Hello, I heard you'd caught a cold. I hope you've recovered. How about you health now?” as a first segmented text item. Next, since the text segmentation unit 850 can detect “well” representing a topic change in the remaining part of the incoming text, the unit 850 outputs “Last weekend, I went on a picnic to the flower park. I could look at many hydrangeas. It's beautiful.” as a second segmented item. Finally, the text segmentation unit 850 outputs “Well, summer vacation is coming soon. I can't wait. I'm going to visit you. I'm looking forward to it.”, the remaining part of the incoming text, as a third segmented text item.

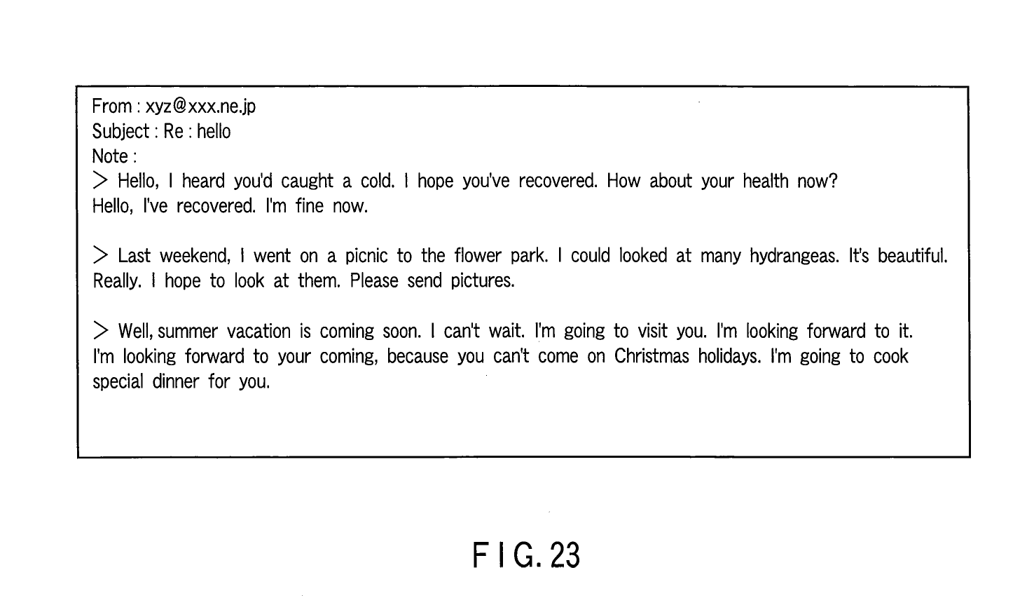

FIG. 22 shows the way return text is generated for the first segmented text item. In this way, return text is generated sequentially for each of the first to third segmented text items. FIG. 23 shows the result of putting together the return-text items for the first to third segmented text items. In FIG. 23, the first to third segmented text items have been quoted and return text has been put together in a thread form. When the return text is displayed in a thread form, the dialogue partner can comprehend the contents of the return text more easily than when the individual return-text items are simply put together.

As described above, the dialogue generation apparatus of the fourth embodiment segments the incoming text once and generates a return-text item for each of the segmented text items. Accordingly, with the dialogue generation apparatus of the fourth embodiment, it is possible to generate more suitable return text for the incoming text.

### Fifth Embodiment

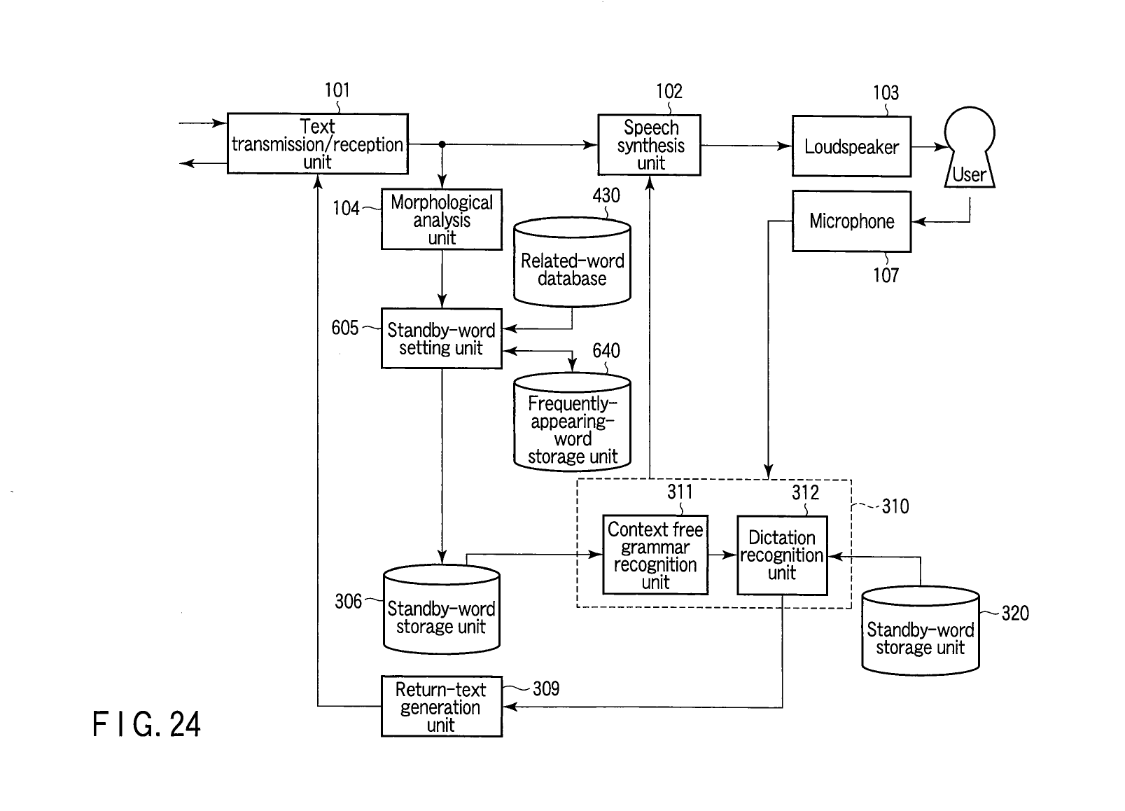

As shown in FIG. 24, a dialogue generation apparatus according to a fifth embodiment of the invention is such that the standby-word setting unit 405 is replaced with a standby-word setting unit 605 and a frequently-appearing-word storage unit 640 is further provided in the dialogue generation apparatus shown in FIG. 11. In the explanation below, the same parts in FIG. 24 as those in FIG. 11 are indicated by the same reference numbers. The explanation will be given, centering on what differs from those of FIG. 11.

In the frequently-appearing-word storage unit 640, the standby word set in the standby-word storage unit 306 by the standby-word setting unit 605 and the number of times the standby word was set (hereinafter, just referred to as the number of setting) have been stored in such a manner that the standby word is caused to correspond to the number of setting. The number of setting is incremented by one each time the standby word is set in the standby-word storage unit 306. The number of setting may be managed independently or collectively for each of the dialogue partners. Moreover, the number of setting may be reset at specific intervals or each time a dialogue is held.

Like the standby-word setting unit 405, the standby-word setting unit 605 sets in the standby-word storage unit 306 the standby word selected from the result of morphological analysis of the incoming text and the related words of the standby word retrieved from the related-word database 430. Moreover, the standby-word setting unit 605 sets the words whose number of setting is relatively large (hereinafter, just referred to as frequently-appearing words) in the frequently-appearing-word storage unit 640 as standby words in the standby-word storage unit 306. The frequently-appearing words may be a specific number of words selected, for example, in descending order of the number of setting (e.g., 5 words) or words whose number of setting is not less than a threshold value (e.g., 10). As described above, the standby-word setting unit 605 updates the number of setting stored in the frequently-appearing-word storage unit 640 each time a standby word is set.

Hereinafter, a return-text generation process performed by the dialogue generation apparatus of FIG. 24 will be explained in detail with reference to FIG. 25.

First, the incoming text received by the text transmission/reception unit 101 is converted into speech data by the speech synthesis unit 102. The speech data is read out by the loudspeaker 103 (step S701).

Moreover, the incoming text is subjected to morphological analysis by the morphological analysis unit 104 (step S702). Next, the standby-word setting unit 605 selects the standby word of the context-free grammar recognition unit 311 from the morphological analysis result in step S702 and retrieves the related words of the standby word from the related-word database 430 (step S703). In addition, the standby-word setting unit 605 searches the frequently-appearing-word storage unit 640 for frequently-appearing words (step S704). Next, the standby-word setting unit 605 sets the standby word selected from the morphological analysis result in step S702, the related words retrieved in step S703, and the frequently-appearing words retrieved in step 704 in the standby-word storage unit 306 (step S705).

After the processes in steps S701 to S705 have been terminated, the dialogue generation apparatus of FIG. 24 waits for the user's speech. The process in step S701 and the processes in steps S702 to S705 may be carried out in reverse order or in parallel. Having received the speech from the user via the microphone 107, the speech recognition unit 310 performs a speech recognition process (step S706). When the user's speech has stopped for a specific length of time, the speech recognition unit 310 terminates the speech recognition process.

If in step S706, the speech recognition unit 310 has succeeded in speech recognition, the process proceeds to step S710. If not, the process proceeds to step S708 (step S707).

In step S708, the speech recognition unit 310 inputs a specific error message to the speech synthesis unit 102. The error message is converted into speech data by the speech synthesis unit 102. The speech data is presented to the user via the loudspeaker 103. With the speech representation of the error message, the user can make sure that the speech recognition by the speech recognition unit 310 has failed. If the user requests the error message be recognized again, the process returns to step S706. If not, the speech recognition unit 310 informs the user via the speech synthesis unit 102 and loudspeaker 103 of the message that the text could not be recognized, and terminates the process (step S709).

In step S710, the speech recognition unit 310 inputs to the speech synthesis unit 102 a specific approval request message together with the speech recognition result in step S707. The speech recognition result and approval request message are converted into speech data by the speech synthesis unit 102. The speech data is presented to the user via the loudspeaker 103. If the user has given approval in response to the approval request message, the process goes to step S712. If not, the process returns to step S706 (step S711). In step S712, the return-text generation unit 309 generates return text on the basis of the speech recognition result approved by the user in step S711 and terminates the process.

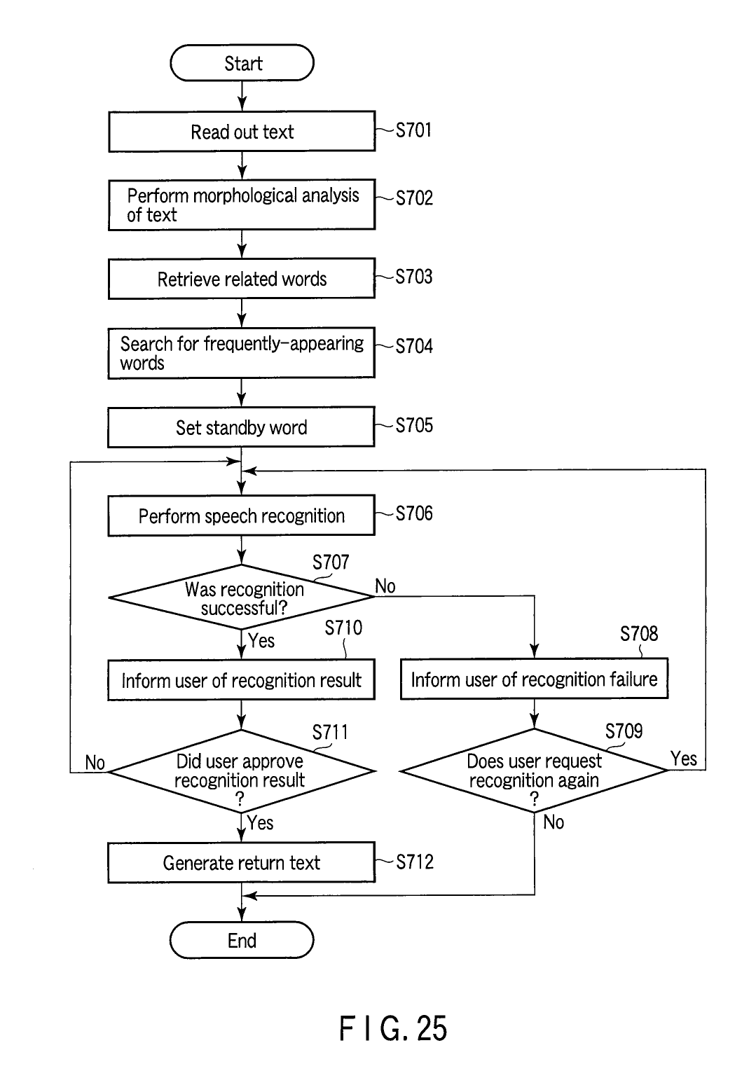

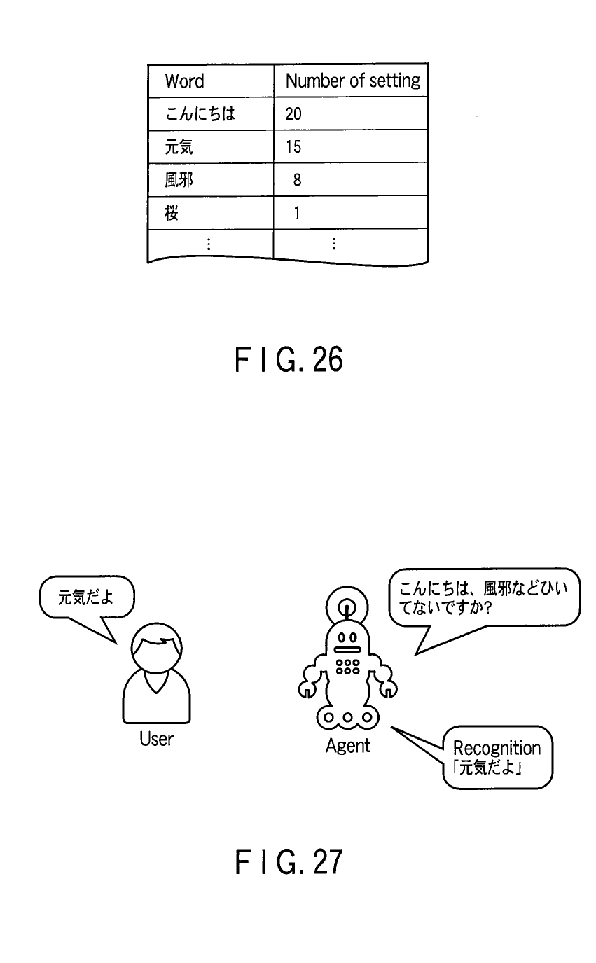

FIG. 27 shows an example of using the dialogue generation apparatus of FIG. 24. Suppose the incoming text is [symbol] [symbol] [symbol] ?” and the contents of FIG. 26 have been stored in the frequently-appearing-word storage unit 640. It is also assumed that the standby-word setting unit 605 sets in the standby-word storage unit 306 not only the standby word selected from the result of morphological analysis of the incoming text and the related words of the standby word retrieved from the related-word database 430 but also the frequently-appearing words [symbol] and [symbol] a [symbol] Here, a frequently-appearing word is a word whose number of setting is not less than 10. If the user's speech is [symbol] since [symbol] has been set in the standby-word setting unit 306 as described above, the context-free grammar recognition unit 311 recognizes them with a high degree of certainty.

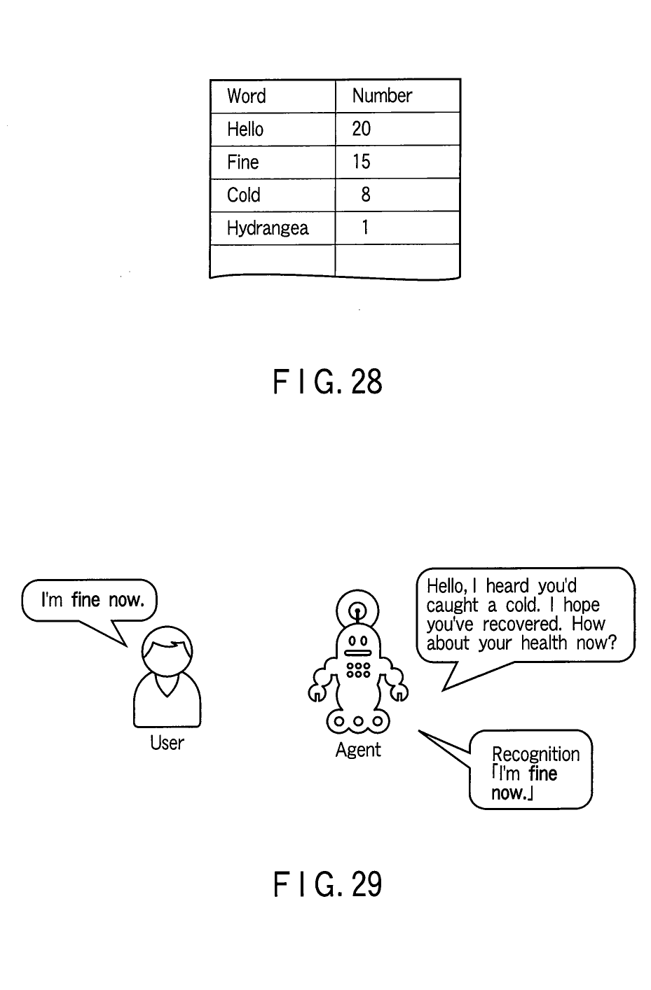

FIG. 29 shows an example of using the dialogue generation apparatus of FIG. 24. Suppose the incoming text is “Hello, I heard you'd caught a cold. I hope you've recovered. How about your health now?” and the contents of FIG. 28 have been stored in the frequently-appearing-word storage unit 640. It is also assumed that the standby-word setting unit 605 sets in the standby-word storage unit 306 not only the standby word selected from the result of morphological analysis of the incoming text and the related words of the standby word retrieved from the related-word database 430 but also the frequently-appearing words “hello” and “fine”. Here, a frequently-appearing word is a word whose number of setting is not less than 10. If the user's speech is “I'm fine now.”, since “fine” has been set in the standby-word setting unit 306 as described above, the context-free grammar recognition unit 311 recognizes them with a high degree of certainty.

As described above, the dialogue generation apparatus of the fifth embodiment sets not only the standby word and related words but also frequently-appearing words as standby words in the context-free grammar recognition process. Accordingly, with the dialogue generation apparatus of the fifth embodiment, since words frequently appeared in the past dialogues are also recognized with a high degree of certainty, it is possible to generate more suitable return text in the dialogue on the basis of the user's speech.

### Sixth Embodiment

The dialogue generation apparatus of each of the first to fifth embodiments has presented a speech via the speech synthesis unit 102 and loudspeaker 103, thereby reading out the incoming text for the user, presenting the speech recognition result to the user, or informing the user of various messages, including an error message and an approval request message. A dialogue generation apparatus according to a sixth embodiment of the invention is such that a display is used in place of the speech synthesis unit 102 and loudspeaker 103 or a display is used together with the speech synthesis unit 102 and loudspeaker 103.

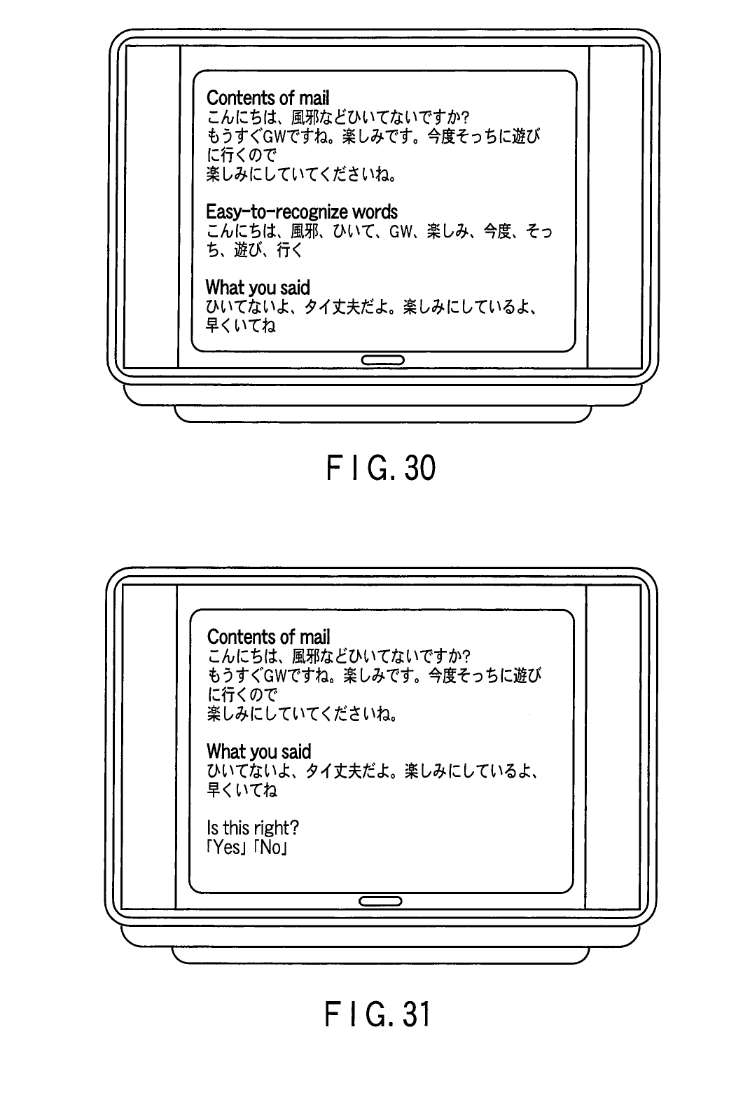

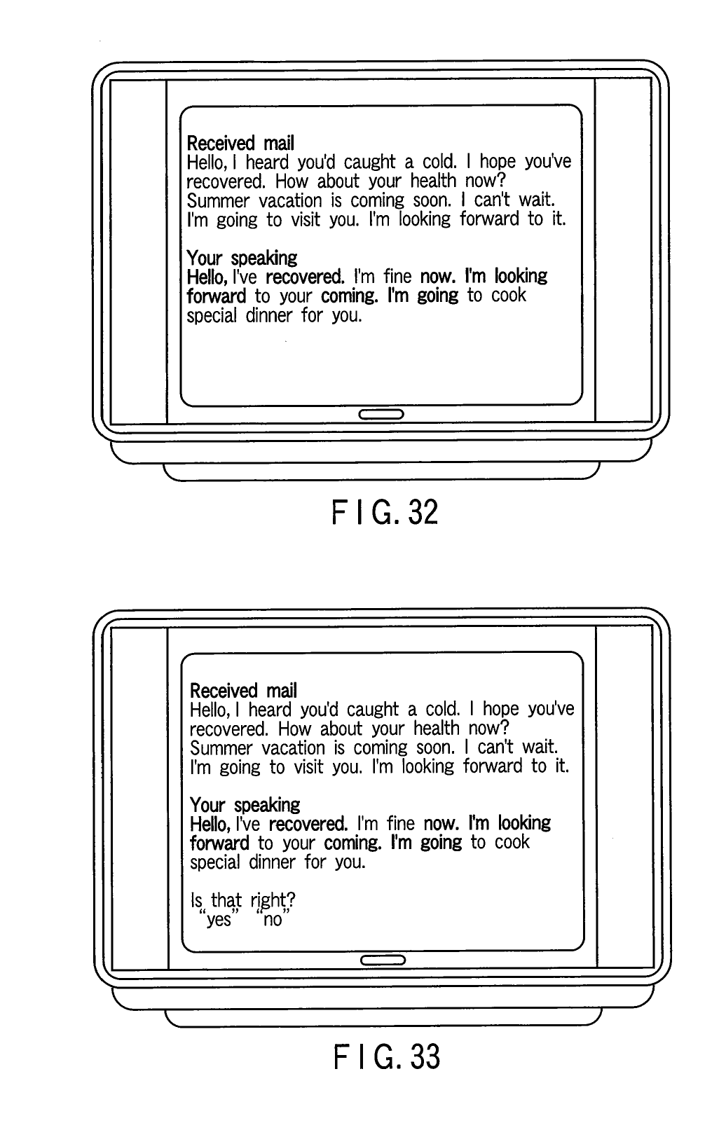

Specifically, as shown in FIG. 30, on the display, the contents of the incoming text are displayed, the priority words set in the standby-word storage unit 106 or the standby words set in the standby-word storage unit 306 are displayed in the form of easy-to-recognize words, or the result of speech recognition of the user's speech is displayed. Moreover, as shown in FIG. 31, various messages, including an approval request message for the speech recognition result, are also displayed on the display. In addition, when the language used in the dialogue generation apparatus of the sixth embodiment is English, the contents appearing on the display are as shown in FIGS. 32 and 33.

As described above, the dialogue generation apparatus of the sixth embodiment uses the display as information presentation means. Accordingly, the dialogue generation apparatus of the sixth embodiment enables incoming text and the result of speech recognition of a speech in response to the incoming text to be checked visually, bringing desirable advantages.

For example, when information is presented in the form of speech, if the user has heard the contents of the presentation wrong or failed to hear the contents, it takes time to present speech again, which makes it troublesome for the user to check the contents of the presentation again. However, this problem can be avoided because information presentation on the screen display enables the user to check the presentation contents in good time. Moreover, if a homophone in the actual speech contents has been included in the result of speech recognition of the user's speech, it can be found out easily. If an image file has been attached to the incoming text, the user can speak while checking the contents of the image file, realizing a more fruitful dialogue. Furthermore, since the user can comprehend words recognized with a high degree of certainty, actually spoken words can be selected efficiently from a plurality of synonyms.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A dialogue generation apparatus comprising:
a transmission/reception unit configured to receive first text and transmit second text serving as a reply to the first text;
a presentation unit configured to present the contents of the first text to a user;
a morphological analysis unit configured to perform a morphological analysis of the first text to obtain first words included in the first text and linguistic information on the first words;
a selection unit configured to select second words that characterize the contents of the first text from the first words based on the linguistic information;
a speech recognition unit configured to perform speech recognition of the user's speech after the presentation of the first text in such a manner that the second words are recognized preferentially, and produce a speech recognition result representing the contents of the user's speech; and
a generation unit configured to generate the second text based on the speech recognition result.

2. The apparatus according to claim 1, further comprising a storage unit configured to store a word and a related word that relates to the word in such a manner that the word is caused to correspond to the related word,
wherein the speech recognition unit performs speech recognition of the user's speech in such a manner that the second words and the related words of the second words are recognized preferentially, and produces the speech recognition result.

3. The apparatus according to claim 1, further comprising a storage unit configured to store a word and the number of times the word was previously selected as the second word in such a manner that the word is caused to correspond to the number,
wherein the speech recognition unit performs speech recognition of the user's speech in such a manner that the second words and at least one of (a) a word whose number of times is not less than a threshold value and (b) a specific number of words selected in descending order of the number of times are recognized preferentially, and produces the speech recognition result.

4. The apparatus according to claim 1, further comprising a segmentation unit configured to segment the first text into a plurality of third text items based on at least one of (a) the presence or absence of a linefeed, (b) the presence or absence of an interrogative sentence, and (c) the presence or absence of a representation of a topic change,
wherein the presentation unit, the morphological analysis unit, the selection unit, and the speech recognition unit perform the presentation of, the morphological analysis of, the acquisition of the linguistic information on, the selection of, and the production of the speech recognition result for each of the plurality of third text items, and the generation unit puts together the speech recognition results for the individual third text items, and generates the second text.

5. The apparatus according to claim 1, wherein
the speech recognition unit includes
a first speech recognition unit configured to perform context-free grammar recognition of the user's speech after the presentation of the first text, and produce a first speech recognition result representing second words included in the user's speech, and
a second speech recognition unit configured to perform dictation recognition of the user's speech, and produce a second speech recognition result representing the contents of the user's speech, and
the generation unit generates the second text based on the first speech recognition result and the second speech recognition result.

6. The apparatus according to claim 1, wherein the speech recognition unit performs dictation recognition.

7. The apparatus according to claim 1, wherein the presentation unit is a display which displays the first text.

8. The apparatus according to claim 7, wherein the presentation unit further displays the second words.

9. A dialogue generation method comprising:
receiving first text;
presenting the contents of the first text to a user;
performing a morphological analysis of the first text to obtain first words included in the first text and linguistic information on the first words;
selecting second words that characterize the contents of the first text from the first words based on the linguistic information;
performing speech recognition of the user's speech after the presentation of the first text in such a manner that the second words are recognized preferentially, and producing a speech recognition result representing the contents of the user's speech;
generating second text serving as a reply to the first text based on the speech recognition result; and
transmitting the second text.
